(19) United States
(12) Patent Application Publication
(10) Pub. No.: US 2023/0312360 A1
(43) Pub. Date: Oct. 5, 2023

(54) METHOD FOR CONTINUOUSLY PRODUCING POLYALUMINUM CHLORIDE FORM ALUMINUM SLAG

(71) Applicant: TONGJI UNIVERSITY, Shanghai (CN)

(72) Inventors: Fengting Li, Shanghai (CN); Ying Wang, Shanghai (CN); Yifan Gu, Shanghai (CN); Tao Kong, Shanghai (CN); Zekun Li, Shanghai (CN)

(21) Appl. No.: 17/848,530

(22) Filed: Jun. 24, 2022

(30) Foreign Application Priority Data
Mar. 30, 2022 (CN) 202210327320.2

(51) Int. Cl. C01F 7/57

(52) U.S. Cl. CPC C01F 7/57

(57) ABSTRACT

Disclosed is a method for continuously producing polyaluminum chloride from aluminum slag, comprising: blending the aluminum slag with water into a slurry in a mixing tank; pumping the slurry and a sodium hydroxide solution into a first mixing reactor; introducing the mixture obtained in the first mixing reactor into a second mixing reactor and pumping hydrochloric acid into the second mixing reactor; and filtering the resulting mixture and allowing filtrate for ripening, polymerization and sedimentation to obtain liquid polyaluminum chloride; wherein each of the reactors is pipeline-shaped, arranged horizontally and provided with a spiral conveyor shaft inside which is arranged horizontally and configured to stir and convey the mixture in a pipeline. This method realizes a continuous treatment of aluminum slag together with a continuous recovery of ammonia nitrogen and produces PAC, thereby achieving resourceful utilization and improved operability.

### CROSS-REFERENCE TO RELATED PATENT APPLICATION

This non-provisional application claims priority to and the benefit of, pursuant to 35 U.S.C. § 119(a), patent application Serial No. CN202210327320.2 filed in China on Mar. 30, 2022. The disclosure of the above application is incorporated herein in its entirety by reference.

### FIELD

The present disclosure relates to the technical field of hazardous waste resourceful treatment, and specifically, to a treatment method for aluminum slag.

### BACKGROUND

The generation of aluminum slag is unavoidable in the aluminum production industry, and the aluminum slag generated during the recycling of aluminum is classified as hazardous waste due to its reactivity and toxicity. A primary aluminum slag generated in the industrial production of aluminum contains 15-30% of metal aluminum, in which most of the aluminum element can be recycled by an slag frying method. A secondary aluminum slag formed by this process still contains 5-8% of elemental aluminum and also 50% or more of alumina, however, such aluminum cannot be extracted by the slag frying method any more. The disposal of aluminum slag as hazardous waste will not only consume a lot of land and cause damage to the ecological environment, but also waste the aluminum therein. Therefore, the resourceful treatment of aluminum slag is very critical.

The metal smelting industry has an extremely urgent need for the resourceful treatment of secondary aluminum slag. Hu Baoguo et al. (Preparation of Polyaluminum Chloride from Aluminum Slag by Acid Dissolution Method, Environmental Protection Of Chemical Industry, 33 (4): 325) adopted an acid dissolution method to prepare polyaluminum chloride by directly dissolving aluminum slag with acid, and conducted orthogonal tests to determine the optimal production parameters for PAC production from aluminum slag for the removal of COD in wastewater. However, the aluminum slag itself contains a relatively high content of ammonia nitrogen and a certain amount of elemental aluminum, thus the direct acid dissolution reaction is too violent, and the generated H₂ will cause safety hazard to the production equipment.

### SUMMARY

The technical problem to be solved by the present disclosure is to solve the above-mentioned shortcomings of the prior art, and a method for continuously producing polyaluminum chloride from aluminum slag is provided.

In order to solve the above-mentioned technical problem, the present disclosure provides a method for continuously producing polyaluminum chloride from aluminum slag, comprising the following steps:
1) mixing and stirring the aluminum slag and water into a slurry in a mixing tank;
2) pumping the slurry into an inlet of a first mixing reactor, and pumping a sodium hydroxide solution;
3) introducing the mixture obtained in the first mixing reactor into a second mixing reactor, and pumping hydrochloric acid into the second mixing reactor; and
4) filtering the mixture obtained in the second mixing reactor, and allowing filtrate to ripening, polymerization and sedimentation to obtain liquid polyaluminum chloride;
wherein the first mixing reactor and the second mixing reactor each are pipeline-shaped, arranged horizontally, and provided with a spiral conveyor shaft inside; wherein the spiral conveyor shaft is arranged horizontally, and configured to stir and convey the mixture from one end to the other end of a pipeline.

Further, the first mixing reactor is provided with an inlet connected to the mixing tank and a sodium hydroxide solution injection port at one end thereof, and with an outlet and an exhaust port at the other end thereof. The second mixing reactor is provided with an inlet connected to the outlet of the first mixing reactor and a hydrochloric acid injection port at one end thereof, and with an outlet and an exhaust port at the other end thereof. A mechanical sealing mechanism is provided between the spiral conveyor shaft and the inner wall of the mixing reactor.

Further, the mixing tank comprises a tank body, a stirring shaft is provided inside the tank body, an aluminum slag feed port and a water injection port are provided on the top of the tank body, a feed bin is provided above the aluminum slag feed port for holding aluminum slag, a discharge port is provided at the bottom of the feed bin, a primary valve is provided at the discharge port, and a secondary valve is provided above the primary valve, and a buffer bin is formed between the primary valve and the secondary valve, wherein only one of the primary valve and the secondary valve is opened during a time period, and both of the primary valve and the secondary valve are opened at a set interval.

Further, the gas overflowing from the exhaust port of the first mixing reactor is introduced into hydrochloric acid.

Further, sodium hydroxide in the sodium hydroxide solution and the aluminum slag are introduced into a mixing reactor at a mass ratio of 1:10-1:20.

Further, the hydrochloric acid has a concentration of 10-20%.

It can be seen from the above technical solutions that the present disclosure has the advantages of a continuous treatment of aluminum slag together with a continuous recovery by the quantitative and continuous supply of both aluminum slag and sodium hydroxide solution, such that the resourceful utilization and excellent operability of industrial continuous production are achieved. In the present disclosure, about 97% of ammonia nitrogen in aluminum slag can be removed, thereby solving the technical difficulty of high ammonia nitrogen content in polyaluminum chloride produced from aluminum slag.

### BRIEF DESCRIPTION OF DRAWINGS

FIG. 1 is a schematic diagram of an equipment used in the present disclosure.

### DETAILED DESCRIPTION

The specific embodiments of the present disclosure will be described in detail below in conjunction with the drawing.

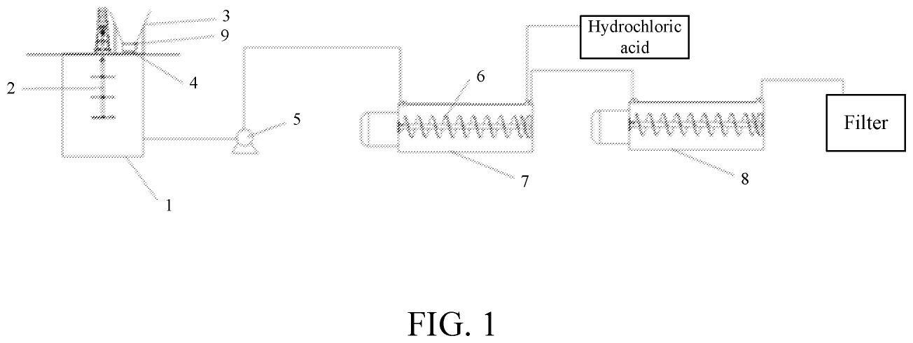

As shown in FIG. 1, the equipment used in the method for continuously producing polyaluminum chloride from aluminum slag of the present disclosure comprises a first mixing reactor 7, a second mixing reactor 8, a filter device 10 and a mixing tank 1. The mixing reactor, which is provided with a horizontally arranged spiral conveyor shaft 6 inside, is in the shape of a pipe and arranged horizontally, and has a length of 10-20 meters. The spiral conveyor shaft plays two roles: one is stirring, and the other is conveying, that is, conveying the mixture of aluminum slag slurry and sodium hydroxide from the inlet to the outlet. The first mixing reactor 7 is provided with an inlet for introducing the aluminum slag slurry and a sodium hydroxide solution injection port at one end, and with an outlet and an exhaust port at the other end, wherein the product resulting from the reaction can be passed through the outlet to perform the next processing, and the exhaust port is used for the overflow of ammonia nitrogen. A mechanical sealing mechanism is provided between the spiral conveyor shaft 6 and the inner wall of the mixing reactor to prevent the generated ammonia gas from overflowing. The second mixed reactor 8 is substantially the same as that of the first mixed reactor 7 in structure, except that the materials to be reacted are different.

The mixing tank comprises a tank body in which a stirring shaft 2 is provided; an aluminum slag feed port and a water injection port are provided on the top of the tank body, and a feed bin 3 is provided above the aluminum slag feed port for holding aluminum slag, which can be fed continuously into the feed bin through a conveyor belt. A discharge port is provided at the bottom of the feed bin, a primary valve 4 is provided at the discharge port, and a secondary valve 9 is provided above the primary valve, and a buffer bin is formed between the primary valve and the secondary valve, wherein both of the primary valve and the secondary valve are automatically closed and opened through a solenoid valve or a cylinder. When the primary valve 4 is opened, the secondary 9 must be in a closed state. Similarly, when the secondary valve is opened, the primary valve must be in a closed state. In addition, both of the primary valve and the secondary valve are opened at a set interval, wherein the secondary valve is opened every 20 s. The aluminum slag is fed into the tank body, with clean water being continuously pumped through the water injection port at a constant flow rate.

When the secondary valve is opened, the aluminum slag falls on the primary valve. When the secondary valve is closed, a certain amount of aluminum slag is stored in the buffer bin formed between the two valves. Therefore, the quantitative and continuous supply of aluminum slag can be realized when opening the primary valve regularly. Thus the dynamic balance of the aluminum slag content of the slurry in the tank body as well as the quantitative supply of the aluminum slag slurry in the mixing reactor are realized.

After stirring evenly, the aluminum slag slurry is pumped into the first mixing reactor by a slurry pump 5, and a sodium hydroxide solution is pumped into the first mixing reactor, wherein the sodium hydroxide solution has a concentration of 10-20%, and the sodium hydroxide in the sodium hydroxide solution and the aluminum slag are introduced into the first mixing reactor at a mass ratio of 1:10-1:20. The ammonia gas generates from the reaction between the ammonia nitrogen in the aluminum slag and sodium hydroxide, which overflows from the exhaust port, and is introduced into 10-20% hydrochloric acid for recovery.

The product of the reaction between aluminum slag and sodium hydroxide solution is mainly sodium aluminate. The mixture resulting from the reaction can be filtered, and then the filtrate is introduced into the second mixing reactor. Alternatively, the mixture resulting from the reaction can be directly introduced into the second mixing reactor, and allowed for a subsequent filtrating. In this embodiment, a subsequent filtrating is selected.

The mixture obtained in the first mixing reactor is introduced into the second mixing reactor, and 10-20% hydrochloric acid is pumped. Sodium aluminate reacts with hydrochloric acid to generate aluminum chloride, while a small amount of metal aluminum reacts with hydrochloric acid to generate hydrogen, which is recovered. The product obtained in the second mixing reactor is filtered to remove unreacted aluminum slag. The obtained aluminum chloride is allowed to ripening, polymerization and sedimentation to obtain liquid polyaluminum chloride, which is then diluted, filtered, concentrated and dried to produce solid polyaluminum chloride.

In the present disclosure, a continuous treatment of aluminum slag together with a continuous recovery of ammonia nitrogen are realized by the quantitative and continuous supply of both aluminum slag and sodium hydroxide solution, such that the resourceful utilization and excellent operability of industrial continuous production are achieved. In addition, about 97% of ammonia nitrogen in aluminum slag can be removed, thereby solving the technical difficulty of high ammonia nitrogen content in polyaluminum chloride produced from aluminum slag, and producing polyaluminum chloride with higher purity and better performance.

What is claimed is:

1. A method for continuously producing polyaluminum chloride from aluminum slag, comprising the following steps:
1) mixing and stirring the aluminum slag and water into a slurry in a mixing tank;
2) pumping the slurry into an inlet of a first mixing reactor, and pumping sodium hydroxide solution;
3) introducing the mixture obtained in the first mixing reactor into a second mixing reactor, and pumping hydrochloric acid into the second mixing reactor; and
4) filtering the mixture obtained in the second mixing reactor, and allowing filtrate for ripening, polymerization and sedimentation to obtain liquid polyaluminum chloride;
wherein the first mixing reactor and the second mixing reactor each are pipeline-shaped, arranged horizontally, and provided with a spiral conveyor shaft inside;
wherein the spiral conveyor shaft is arranged horizontally, and configured to stir and convey the mixture from one end to the other end of a pipeline.

2. The method for continuously recovering ammonia from hazardous waste of aluminum slag according to claim 1, wherein the first mixing reactor is provided with an inlet connected to the mixing tank and a sodium hydroxide solution injection port at one end thereof, and with an outlet and an exhaust port at the other end thereof;
the second mixing reactor is provided with an inlet connected to the outlet of the first mixing reactor and a hydrochloric acid injection port at one end thereof, and with an outlet and an exhaust port at the other end thereof; and
a mechanical sealing mechanism is provided between the spiral conveyor shaft and the inner wall of the mixing reactor.

3. The method for continuously recovering ammonia from hazardous waste of aluminum slag according to claim 2, wherein
the mixing tank comprises a tank body,
a stirring shaft is provided inside the tank body,
an aluminum slag feed port and a water injection port are provided on the top of the tank body,
a feed bin is provided above the aluminum slag feed port for holding the aluminum slag,
a discharge port is provided at the bottom of the feed bin,
a primary valve is provided at the discharge port,
a secondary valve is provided above the primary valve, and
a buffer bin is formed between the primary valve and the secondary valve,
wherein only one of the primary valve and the secondary valve is opened during a time period, and both of the primary valve and the secondary valve are opened at a set interval.

4. The method for continuously recovering ammonia from hazardous waste of aluminum slag according to claim 1, wherein gas overflowing from the exhaust port of the first mixing reactor is introduced into hydrochloric acid.

5. The method for continuously recovering ammonia from hazardous waste of aluminum slag according to claim 1, wherein sodium hydroxide in the sodium hydroxide solution and the aluminum slag are introduced into the mixing reactor at a mass ratio of 1:10-1:20.

6. The method for continuously recovering ammonia from hazardous waste of aluminum slag according to claim 1, wherein the hydrochloric acid has a concentration of 10-20%.
